(19) United States
(12) Patent Application Publication
(10) Pub. No.: US 2023/0304922 A1
(43) Pub. Date: Sep. 28, 2023

(54) SPECTROSCOPE AND ANALYSIS SYSTEM

(71) Applicants: Tetsuroh TATEBE, Osaka (JP); Hidetaka NOGUCHI, Hyogo (JP); Toshiaki TOKITA, Kanagawa (JP)

(72) Inventors: Tetsuroh TATEBE, Osaka (JP); Hidetaka NOGUCHI, Hyogo (JP); Toshiaki TOKITA, Kanagawa (JP)

(21) Appl. No.: 18/122,759

(22) Filed: Mar. 17, 2023

(30) Foreign Application Priority Data
Mar. 23, 2022 (JP) 2022-047143
Jan. 27, 2023 (JP) 2023-011088

(51) Int. Cl. G01N 21/25

(52) U.S. Cl. CPC G01N 21/255; G01N 2201/0221; G01N 2201/025; G01N 2201/0635; G01N 2201/0636

(57) ABSTRACT

A spectroscope includes: a light incidence section that allows light from an outside to be incident; a diffraction grating that disperses wavelengths of the light incident on the diffraction grating by the light incidence section; a light reflector having a reflecting surface having an inclination variable around a rotation axis of the reflecting surface; and a light emitter that emits the light reflected by the light reflector to the outside. At least one of the light incidence section, the diffraction grating, and the light reflector, and the light emitter are changeable in a direction orthogonal to the rotation axis. The position of the light emitter is changeable in a direction along a center axis of the light emitted from the light emitter.

### CROSS-REFERENCE TO RELATED APPLICATIONS

This patent application is based on and claims priority pursuant to 35 U.S.C. § 119(a) to Japanese Patent Application Nos. 2022-047143, filed on Mar. 23, 2022, and 2023-011088, filed on Jan. 27, 2023, in the Japan Patent Office, the entire disclosure of which is hereby incorporated by reference herein.

### BACKGROUND

### Technical Field

The present disclosure relates to a spectroscope and an analysis system.

### Related Art

In related art, a spectroscope that disperses measurement light to obtain an optical spectrum on a wavelength basis is known. Such a spectroscope is used in various applications such as an application of determining the material of plastic for recycling resources.

For example, the background spectroscope includes a rotatable diffraction grating and rotatable reflecting means. The spectroscope corrects a deviation of the optical-axis in a direction intersecting with the optical-axis, the deviation which is generated when the diffraction grating is rotated to increase diffraction efficiency, by rotation of the reflecting means.

However, the spectroscope may vary in accordance with a dimensional tolerance or an assembly tolerance of a component. The above-described spectroscope corrects a deviation of the optical-axis in the direction intersecting with the optical-axis; however does not correct a deviation of the focus position or the like of emission light emitted from the spectroscope in the optical-axis direction.

### SUMMARY

Embodiments of the present disclosure provide a spectroscope including a light incidence section that allows light from an outside to be incident; a diffraction grating that disperses wavelengths of the light incident on the diffraction grating by the light incidence section; a light reflector having a reflecting surface having an inclination variable around a rotation axis of the reflecting surface; and a light emitter that emits the light reflected by the light reflector to the outside. At least one of the light incidence section, the diffraction grating, and the light reflector, and the light emitter are changeable in a direction orthogonal to the rotation axis. The position of the light emitter is changeable in a direction along a center axis of the light emitted from the light emitter.

Embodiments of the present disclosure provide a spectroscope including a light incidence section that allows light from an outside to be incident; a concave diffraction grating that disperses wavelengths of the light incident on the concave diffraction grating by the light incidence section; a light reflector having a reflecting surface swingable around a predetermined rotation axis; and a light emitter that emits the light reflected by the light reflector to the outside. At least one of the light incidence section, the concave diffraction grating, and the light reflector, and the light emitter are adjustable in a direction orthogonal to the rotation axis.

Embodiments of the present disclosure provide a spectroscope including a light incidence section that allows light from an outside to be incident; a concave diffraction grating that disperses wavelengths of the light incident on the concave diffraction grating by the light incidence section; a light reflector having a reflecting surface swingable around a predetermined rotation axis; and a light emitter that emits the light reflected by the light reflector to the outside. At least one of postures the light incidence section, the concave diffraction grating, and the light emitter is rotated around an axis parallel to the rotation axis to adjust the at least one of the postures of the light incidence section, the concave diffraction grating, and the light emitter.

Embodiments of the present disclosure provide an analysis system including the spectroscope; and a processor that analyzes a spectrum obtained by the spectroscope.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a perspective view illustrating a general arrangement of a spectroscope according to a first embodiment;

FIG. 2 is a cross-sectional view illustrating a Rowland circle in the spectroscope in FIG. 1:

FIG. 3 is a cross-sectional view taken along line IIII-III in FIG. 1;

FIGS. 4A, 4B, 4C, 4D, 4E, and 4F are views each illustrating a configuration for a positional change according to the first embodiment, FIG. 4A being a top view of a first example, FIG. 4B being a front view of the first example, FIG. 4C being a top view of a second example, FIG. 4D being a front view of the second example, FIG. 4E being a top view of a third example, FIG. 4F being a front view of the third example;

FIG. 5 is a graph presenting an example of an optical spectrum near a wavelength λ1;

FIG. 6A is a graph presenting an example of optical spectra near wavelengths λ1, λ2, and λ3;

FIG. 6B is a diagram illustrating a relationship example between a diffraction angle when light having each wavelength dispersed by a concave diffraction grating is reflected by a movable light reflector and an angle at which the light is reflected by the movable light reflector;

FIG. 6C is a graph presenting an example of angles of the movable light reflector when light having each wavelength passes through a second light passing portion with the highest light intensity in a case where predetermined tolerances are given to the position and posture of each of the concave diffraction grating, the movable light reflector, and a light emitter;

FIG. 6D is a graph presenting an example of values of full width at half maximum of light illuminance when light having each wavelength passes through the second light passing portion with the highest light intensity in a case where predetermined tolerances are given to the position and posture of each of the concave diffraction grating, the movable light reflector, and the light emitter;

FIG. 7 is a diagram illustrating an example of positional changes of the concave diffraction grating and the light emitter:

FIG. 8 is a view illustrating an example of a grating of the concave diffraction grating:

FIGS. 9A, 9B, and 9C are views each illustrating a change in focus position of emission light when the position of the concave diffraction grating is changed, FIG. 9A illustrating a first example, FIG. 9B illustrating a second example, FIG. 9C illustrating a third example;

FIG. 10 is a diagram illustrating an example of a positional change of a light incidence section:

FIG. 11 is a diagram illustrating an example of a positional change of the movable light reflector;

FIG. 12 is a diagram illustrating an example of changing the positions of the light incidence section, the concave diffraction grating, the movable light reflector, and the light emitter;

FIG. 13 is a cross-sectional view illustrating an example of an angle adjustment mechanism of the concave diffraction grating;

FIG. 14 is a bottom view illustrating the example of the angle adjustment mechanism of the concave diffraction grating;

FIG. 15 is a cross-sectional view illustrating another example of the angle adjustment mechanism of the concave diffraction grating;

FIG. 16 is a bottom view illustrating the other example of the angle adjustment mechanism of the concave diffraction grating;

FIG. 17 is a graph presenting an example of angles of the movable light reflector in a case where predetermined tolerances are given to the position and posture of each of the concave diffraction grating, the movable light reflector, and the light emitter and the position of the concave diffraction grating is adjusted:

FIG. 18 is a graph presenting an example of values of full width at half maximum of light illuminance when light having each wavelength passes through the second light passing portion with the highest light intensity in a case where predetermined tolerances are given to the position and posture of each of the concave diffraction grating, the movable light reflector, and the light emitter and the position of the light emitter is adjusted;

FIG. 19 is a graph presenting an example of values of full width at half maximum of light illuminance when light having each wavelength passes through the second light passing portion with the highest light intensity in a case where predetermined tolerances are given to the position and posture of each of the concave diffraction grating, the movable light reflector, and the light emitter and the positions of the concave diffraction grating and the light emitter are adjusted simultaneously:

FIG. 20 is a graph presenting an example of angles of the movable light reflector in a case where predetermined tolerances are given to the position and posture of each of the concave diffraction grating, the movable light reflector, and the light emitter and the posture of the concave diffraction grating is adjusted:

FIG. 21 is a diagram illustrating a general arrangement of an analysis system according to a second embodiment; and

FIG. 22 is a flowchart presenting an example of a resin determination operation w % ben the analysis system according to the second embodiment is applied to a resin determination apparatus.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a”, “an”, and “the” are intended to include the plural forms as well, unless the context clearly indicates otherwise.

Embodiments for implementing the present disclosure are described below in detail referring to the drawings. Like reference signs are applied to identical or corresponding components throughout the drawings and redundant description thereof may be omitted where appropriate.

The embodiment described below is illustrative of a spectroscope for embodying the technical idea of the present disclosure, and the present disclosure is not limited to the embodiment described below. The dimensions, materials, shapes, relative arrangements, and so forth, of the components described below are not intended to limit the scope of the present disclosure thereto, and are intended to be examples unless otherwise specifically indicated. The size, positional relationship, and so forth, of members illustrated in the drawings may be exaggerated for clarity of description.

### First Embodiment

### Example of General Arrangement of Spectroscope 10

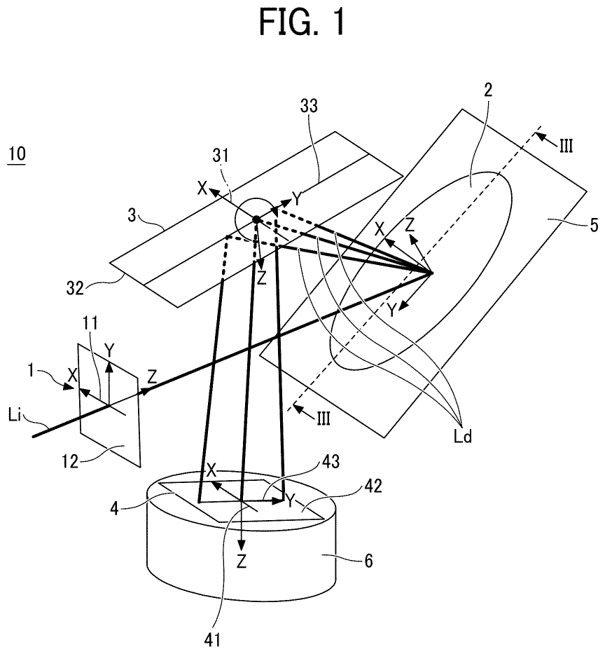

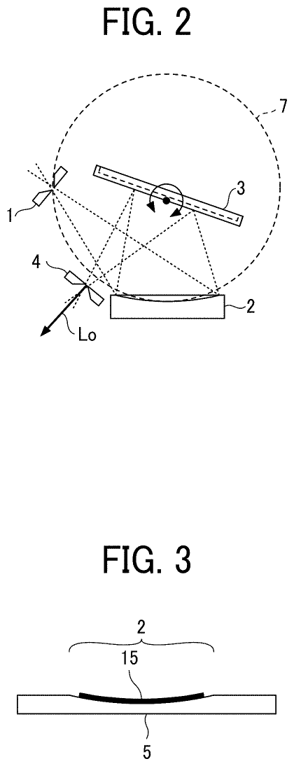

A configuration of a spectroscope 10 according to a first embodiment is described referring to FIGS. 1 and 2. FIG. 1 is a perspective view illustrating a general arrangement of the spectroscope 10. FIG. 2 is a cross-sectional view illustrating a Rowland circle 7 in the spectroscope 10.

As illustrated in FIGS. 1 and 2, the spectroscope 10 includes a light incidence section 1, a concave diffraction grating 2, a movable light reflector 3, a light emitter 4, a substrate 5, and a light detector 6. FIG. 1 also indicates a local coordinate system of each component.

The light incidence section 1 is an example of light incidence means that allows light Li from the outside to be incident. The light incidence section 1 allows the light Li from the outside to be incident on the spectroscope 10 through a first light passing portion 11. A region of the light incidence section 1 other than the first light passing portion 11 defines a first light non-passing portion 12 that does not allow the light Li to pass therethrough. The first light passing portion 11 has, for example, a pinhole shape or a slit shape, and is provided to determine the incident position of light and to increase the wavelength resolution.

The concave diffraction grating 2 is an example of a diffraction grating that disperses the wavelengths of the light Li incident on the concave diffraction grating 2 by the light incidence section 1. The concave diffraction grating 2 is formed on the substrate 5. The concave diffraction grating 2 diffracts the light Li to disperse the wavelengths of the light Li. and reflects wavelength dispersed light Ld toward the movable light reflector 3. Beams of light having different wavelengths included in the wavelength dispersed light Ld propagate while being converged, are incident at different positions on a reflection line 33 on a reflecting surface 32, and are reflected by the reflecting surface 32.

The material of the substrate 5 may be, but is not limited to, for example, a semiconductor, a glass, a metal, or a resin. The concave diffraction grating 2 may be directly formed on the substrate 5, or may be formed on a thin film layer, for example, a resin layer, formed on the substrate 5.

The movable light reflector 3 is an example of reflecting means having the reflecting surface 32 whose inclination is variable. The movable light reflector 3 reflects the wavelength dispersed light Ld caused by the concave diffraction grating 2 toward the light emitter 4 by the reflecting surface 32.

The movable light reflector 3 has a swing axis 31. The movable light reflector 3 swings around the swing axis 31 to change the inclination of the reflecting surface 32 that reflects the wavelength dispersed light Ld. Scanning with the wavelength dispersed light Ld is performed in accordance with the inclination of the reflecting surface 32.

The movable light reflector 3 can be formed in a thin and small shape on a semiconductor substrate by, for example, a semiconductor process or a micro electro mechanical systems (MEMS) process. Since the movable light reflector 3 is formed on the semiconductor substrate, a driving element section for piezoelectric driving, electrostatic driving, electromagnetic driving, or the like, can be monolithically formed on the semiconductor substrate. Thus, the spectroscope 10 can drive the movable light reflector 3 without using an external driving device such as a motor, thereby attaining a further decrease in size. However, the substrate on which the movable light reflector 3 is formed is not limited to a semiconductor, and may be a glass, a metal, a resin, or the like.

The light emitter 4 is an example of light emitting means that emits, to the outside through a second light passing portion 41, part of the beams of light having the different wavelengths included in the wavelength dispersed light Ld reflected by the movable light reflector 3. The part of the beams of light having the different wavelengths included in the wavelength dispersed light Ld is emitted to the outside through the second light passing portion 41. A region of the light emitter 4 other than the second light passing portion 41 defines a second light non-passing portion 42 that does not allow the wavelength dispersed light Ld to pass therethrough.

The second light passing portion 41 has, for example, a pinhole shape or a slit shape, and is provided to determine the emission position of the part of the beams of light having the different wavelengths included in the wavelength dispersed light Ld and to increase the wavelength resolution.

The beams of light having the different wavelengths included in the wavelength dispersed light Ld are reflected at different positions on the reflection line 33 on the reflecting surface 32 and are incident at different positions on an emission line 43 on the light emitter 4.

Since the reflecting surface 32 of the movable light reflector 3 changes the inclination around the swing axis 31, the incident position on the emission line 43 of each of the beams of light having the different wavelengths included in the wavelength dispersed light Ld changes.

Among the beams of light having the different wavelengths included in the wavelength dispersed light Ld, light incident on the position of the second light passing portion 41 passes through the second light passing portion 41 and is emitted. The light emitter 4 can emit light having a wavelength included in the wavelength dispersed light Ld and determined by the swing angle of the movable light reflector 3 through the second light passing portion 41. Emission light Lo illustrated in FIG. 2 represents light emitted from the light emitter 4.

The light incidence section 1 and the light emitter 4 each may be formed on a substrate. In this case, the material of the substrate may be, but is not limited to, for example, a semiconductor, a glass, a metal, or a resin. However, it is desirable to use a semiconductor as the material of the substrate because the light incidence section 1 and the light emitter 4 can be formed with high precision and at low cost using a semiconductor process, a MEMS process, or the like.

The light detector 6 is an example of light detecting means that detects the emission light Lo from the light emitter 4. The light detector 6 may use, for example, a photodiode. When light Li in a near infrared region is dispersed, an indium gallium arsenide (InGaAs) photodiode is desirable.

In the spectroscope 10, the above-described components are disposed at predetermined positions as illustrated in FIG. 1, and are secured to a housing, a jig, or the like, so as to maintain predetermined postures.

In FIG. 2, a circle indicated by a broken line represents a Rowland circle 7. A Rowland circle is a circle having a diameter of a line connecting the center of curvature of the concave diffraction grating 2 and the center of a concave curved surface included in the concave diffraction grating 2. In the present embodiment, at least the light incidence section 1 and the concave diffraction grating 2 are disposed on the Rowland circle 7. The light emitter 4 is arranged on the Rowland circle 7 depending on the arrangement of the movable light reflector 3; however, FIG. 1 illustrates a configuration in which the light emitter 4 is not arranged on the Rowland circle 7 as an example.

### Example of Configuration of Concave Diffraction Grating 2

FIG. 3 illustrates a configuration of the concave diffraction grating 2, and is a cross-sectional view taken along line III-III in FIG. 1.

As illustrated in FIG. 3, the concave diffraction grating 2 includes a reflecting member 15. Specifically, a concave curved surface is formed in an upper surface of the substrate 5, and a diffraction grating is formed on the concave curved surface. Furthermore, the reflecting member 15 using a metal material, such as aluminum (Al), silver (Ag), gold (Au), or platinum (Pt), for increasing the reflectivity is formed on a surface of the diffraction grating. For example, a resist is applied to the concave curved surface of the substrate 5, a grating pattern is formed in the resist using an interference exposure method or the like, and dry etching or the like is performed, thereby forming a diffraction grating on the concave curved surface of the substrate 5.

The concave diffraction grating 2 may have, for example, a rectangular shape, a sine wave shape, or a sawtooth wave shape as the sectional shape of the groove portion of the diffraction grating.

The concave diffraction grating 2 does not have to include the reflecting member 15. The configuration of the concave diffraction grating 2 is not limited to the one illustrated in FIG. 3 as long as the concave diffraction grating 2 has a similar wavelength dispersion function. When parallel light is incident from the light incidence section 1, a plane diffraction grating may be used instead of the concave diffraction grating 2 to obtain a similar wavelength dispersion function. In this case, a complicated device configuration (for example, a collimator optical system for converting light into parallel light at a position in front or rear of the plane diffraction grating) is not used, while the complicated device is used when a configuration that changes the inclination of the plane diffraction grating is employed.

In the concave diffraction grating 2, a resin layer in a thin film form may be formed on the concave curved surface formed in the upper surface of the substrate 5, and a diffraction grating may be formed in the resin layer. In this case, to increase the reflectivity, a reflecting member made of a metal material, such as Al, Ag, Au, or Pt, is desirably formed on a surface of the diffraction grating formed in the resin layer.

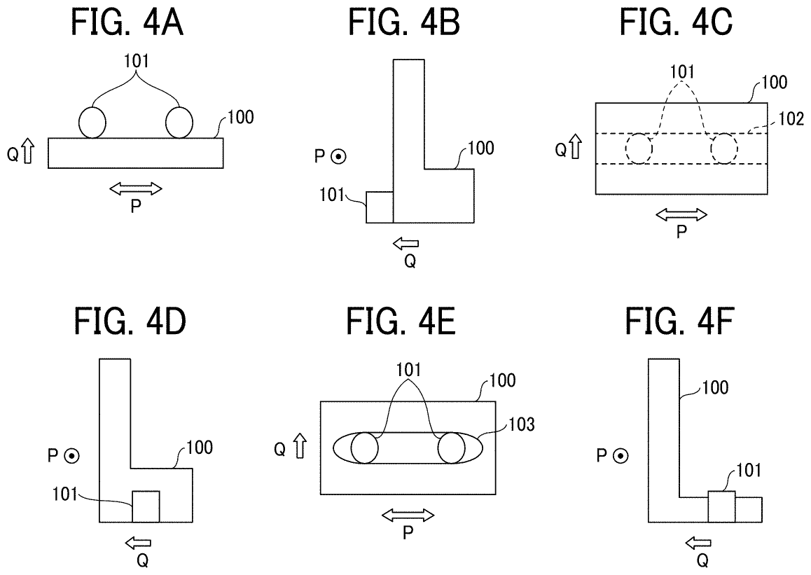

FIGS. 4A to 4F each illustrate a configuration for a positional change according to the present embodiment. FIG. 4A is a top view of a first example. FIG. 4B is a front view of the first example. FIG. 4C is a top view of a second example. FIG. 4D is a front view of the second example. FIG. 4E is a top view of a third example. FIG. 4F is a front view of the third example.

The spectroscope 10 includes a holder 100 and two positioning pins 101 as a configuration for changing the position of each of the light incidence section 1, the concave diffraction grating 2, the movable light reflector 3, and the light emitter 4.

In FIGS. 4A to 4F, the top view is a view of the holder 100 and the positioning pins 101 in a direction orthogonal to each of a direction indicated by arrow P and a direction indicated by arrow Q. The direction indicated by arrow P is a direction in which the holder 100 slides to change its position. The direction indicated by arrow Q is a direction in which the holder 100 comes into contact with the positioning pins 101. The front view is a view of the holder 100 and the positioning pins 101 in the direction indicated by arrow P.

The configurations of the holder 100 and the two positioning pins 101 can be appropriately changed in accordance with the position and shape of each of the light incidence section 1, the concave diffraction grating 2, the movable light reflector 3, and the light emitter 4 to which the holder 100 and the two positioning pins 101 are applied. FIGS. 4A and 4B illustrate a first example. FIGS. 4C and 4D illustrate a second example. FIGS. 4E and 4F illustrate a third example.

In the first example, a side surface (a surface orthogonal to the direction indicated by arrow Q) of a holder 100 comes into contact with positioning pins 101, and hence the holder 100 is positioned in the direction indicated by arrow Q. In this state, the position of the holder 100 can be changed in the direction indicated by arrow P.

In the second example, positioning pins 101 enter a groove 102 formed in a bottom surface (a surface opposite to an upper surface) of the holder 100 to position the holder 100 in the direction indicated by arrow Q. In this state, the position of the holder 100 can be changed in the direction indicated by arrow P.

In the third example, positioning pins 101 enter a long hole 103 formed in a bottom surface of a holder 100 to position the holder 100 in the direction indicated by arrow Q. In this state, the position of the holder 100 can be changed in the direction indicated by arrow P.

The long hole 103 may be a hole extending through the holder 100 or may be a hole not extending through the holder 100 in a direction orthogonal to each of the direction indicated by arrow P and the direction indicated by arrow Q.

### Example of Optical Spectrum by Spectroscope 10

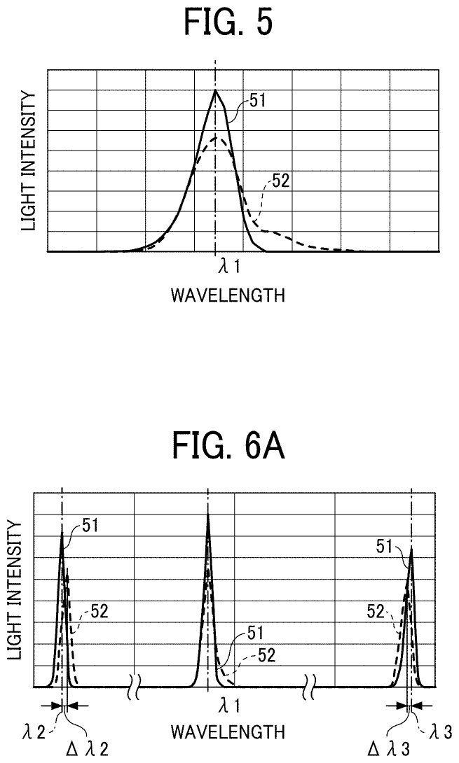

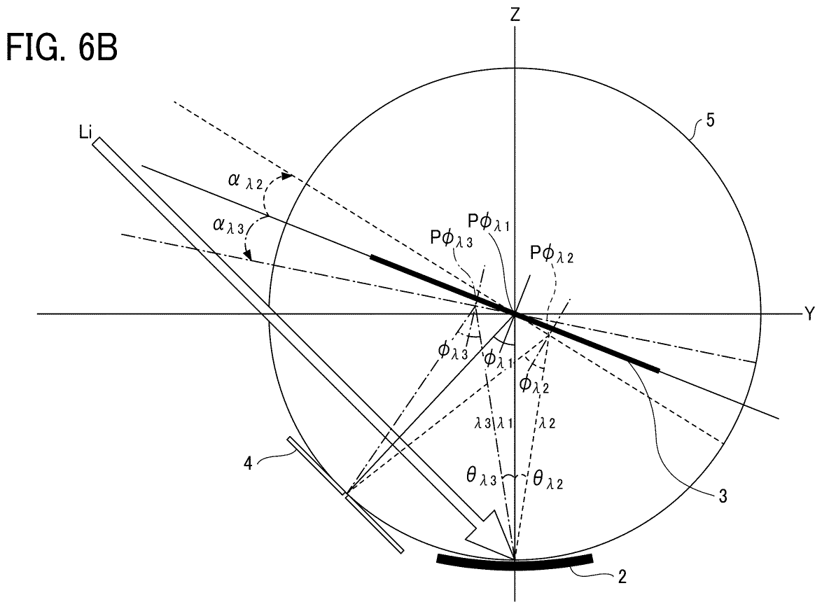

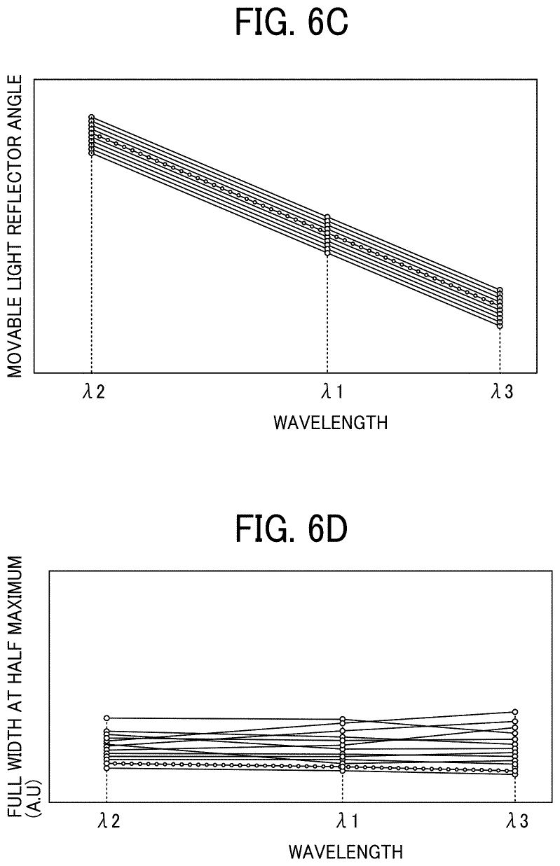

An optical spectrum by the spectroscope 10 is described referring to FIGS. 5 and 6A. FIG. 5 is a graph presenting an optical spectrum near a wavelength λ1. FIG. 6A is a graph presenting optical spectra near wavelengths λ1, λ2, and λ3. As illustrated in FIGS. 5 and 6A, the optical spectrum represents a light intensity on a wavelength basis.

A graph 51 with a solid line indicates an optical spectrum in a state in which the focus position of the emission light Lo substantially matches the position of the second light passing portion 41 in the optical-axis direction of the emission light Lo. The peak wavelengths are λ1, λ2, and λ3. In contrast, a graph 52 with a broken line indicates an optical spectrum in a state in which the focus position of the emission light Lo does not match the position of the second light passing portion 41 in the optical-axis direction of the emission light Lo. The peak wavelengths are λ1′, λ2′, and λ3′. The positional deviation in the optical-axis direction of the emission light Lo between the focus position of the emission light Lo and the position of the second light passing portion 41 is hereinafter referred to as a deviation in the optical-axis direction. Also, hereinafter, when the peak wavelength changes due to a positional variation or the like from the normal state, such as λ1′ for λ1, λ2′ for λ2, and 3′ for λ3, the phenomenon is referred to as a wavelength shift, and the differences (λ1′-λ1, λ2′-λ2, λ3′-λ3) are referred to as wavelength shift amounts.

As indicated by the graph 52 in FIG. 5, when there is a deviation in the optical-axis direction, the light intensity decreases and the half value width of the spectrum increases. The decrease in light intensity and the increase in half value width cause decreases in signal/noise (SN) ratio and wavelength resolution in spectral diffraction, and a decrease in performance of the spectroscope 10. Such a deviation in the optical-axis direction is generated in accordance with a dimensional error or an assembly error of each of the components such as the light incidence section 1, the concave diffraction grating 2, the movable light reflector 3, and the light emitter 4. Even when the spectroscope 10 is manufactured within the tolerance range, a deviation in the optical-axis direction may occur due to an error within a range of dimensional tolerance or assembly tolerance of each component.

As presented in FIG. 6A, when beams of light having the three wavelengths λ1, λ2, and λ3 have deviations in the optical-axis direction, a wavelength shift Δλ2 is generated for the wavelength λ2 that is separated from the wavelength λ1 near the center, and a wavelength shift Δλ3 is generated for the wavelength λ3 that is separated from the wavelength 1 near the center. When the focus position and the position of the light emitter 4 are deviated from each other, the wavelength shift amount of λ1 near the center of the spectral wavelengths is small, whereas the wavelength shift amounts of 0.2 and λ3 separated from the center of the spectral wavelengths are large. These wavelength shifts also cause a decrease in performance of the spectroscope 10.

FIG. 6B illustrates a specific phenomenon. FIG. 6B is a diagram illustrating a relationship among diffraction angles θλ1, θλ2, and θλ3 when beams of light having the wavelengths λ1, λ2, and λ3 dispersed by the concave diffraction grating 2 are reflected by the movable light reflector 3, angles αλ1, αλ2, and αλ3 of the movable light reflector 3, and angles φλ1, φλ2, and φλ3 at which the beams of light are reflected by the movable light reflector 3 (in this case, representing the sum of the incident angle and the reflection angle). The beams of light having the wavelengths λ1, λ2, and λ3 represent principal rays. In FIG. 6B, light having the wavelength λ1 is indicated by a solid line, light having the wavelength λ2 is indicated by a broken line, and light having the wavelength λ3 is indicated by a one dot-chain line.

The diffraction angle is indicated as a rotation angle with respect to the normal direction (Z-axis direction) of the concave diffraction grating 2. It is assumed that the diffraction angle θλ1 coincides with the normal direction, that is, θλ1=0. The angle of the movable light reflector 3 is indicated while it is assumed that the angle under a condition that the light having the wavelength λ1 passes through the second light passing portion 41 is 0°, that is, αλ1=0. In an ideal state, θλ1=αλ=0, θλ2=αλ2, and θλ3=αλ3 are established, and φλ1=φλ2=φλ3 is established. As illustrated in FIG. 6B, the beams of light having the wavelengths are reflected at different positions Pλ1. Pλ2, and Pλ3 of the movable light reflector 3. Thus, for example, when the rotation axis of the movable light reflector 3 is deviated from an ideal position, for example, a position on the X-axis orthogonal to each of the Y-axis and the Z-axis illustrated in FIG. 6B, the beams of light having the wavelengths reach different positions. This is a disadvantage specific to a spectroscope using the movable light reflector 3.

FIG. 6C presents angles of the movable light reflector 3 when light having each of the wavelengths λ1, λ2, and λ3 passes through the second light passing portion 41 with the highest light intensity in a case where predetermined tolerances are given to the position and posture of each element of the concave diffraction grating 2, the movable light reflector 3, and the light emitter 4. A dotted line indicates an angle of a design median value without a positional variation. The larger the difference in angle from the design median value, the larger the wavelength shift amount. The position of each element is adjusted to reduce the variation in angle.

FIG. 6D presents values of full width at half maximum of light illuminance when light having each of the wavelengths λ1, λ2, and λ3 passes through the second light passing portion 41 with the highest light intensity in a case where predetermined tolerances are given to the position and posture of each element of the concave diffraction grating 2, the movable light reflector 3, and the light emitter 4. A dotted line indicates a value of a design median value without a positional variation. The full width at half maximum increases with a variation in position from the design median value. The wavelength resolution may be defined as the reciprocal of the full width at half maximum.

As described above, to ensure the performance of the spectroscope 10 at a high level and to reduce the difference in performance between spectroscopes 10, it is desirable to reduce a deviation in the optical-axis direction.

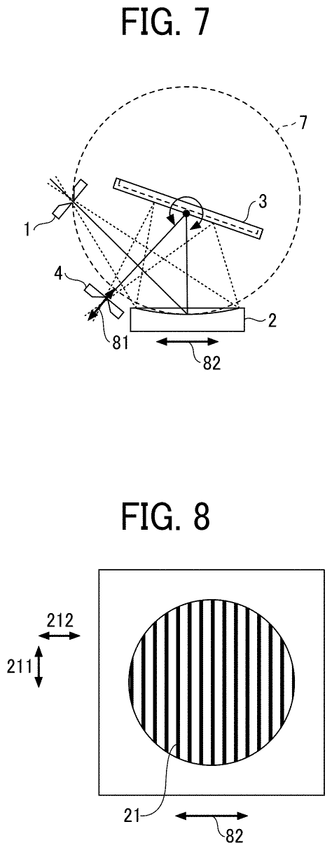

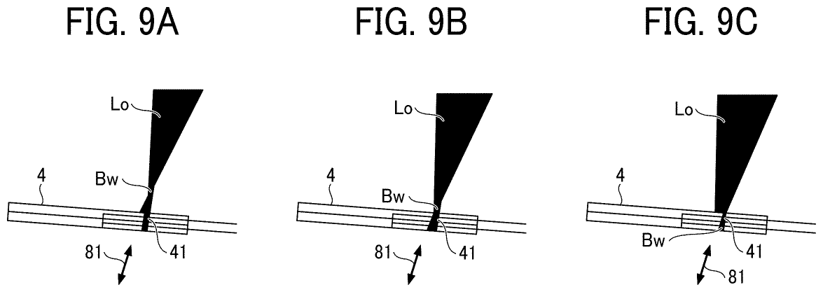

Example of Positional Changes of Concave Diffraction Grating 2 and Light Emitter 4 FIG. 7 is a diagram illustrating an example of positional changes of the concave diffraction grating 2 and the light emitter 4. FIG. 8 is a view illustrating a grating 21 of the concave diffraction grating 2. FIGS. 9A, 9B, and 9C are views each illustrating a change in focus position of the emission light Lo when the position of the concave diffraction grating 2 is changed. FIG. 9A illustrates a first example. FIG. 9B illustrates a second example. FIG. 9C illustrates a third example.

In the present embodiment, as illustrated in FIG. 7, the position of the concave diffraction grating 2 can be changed in a first tangential direction 82 of the Rowland circle 7 near the position at which the concave diffraction grating 2 is disposed. As illustrated in FIG. 8, in the concave diffraction grating 2, a plurality of gratings 21 extending in an extension direction 211 are arranged in an arrangement direction 212. The arrangement direction 212 is an example of a predetermined direction in which the plurality of gratings 21 are arranged. The first tangential direction 82 is a direction in the arrangement direction 212, and is a direction substantially orthogonal to the extension direction 211.

Changing the position of the concave diffraction grating 2 in the first tangential direction 82 changes the incident angle of the light from the light incidence section 1 onto the concave diffraction grating 2. Thus, the focus position of the emission light Lo can be changed.

In FIG. 9A, a focus position Bw of the emission light Lo is located on the movable light reflector 3 side with respect to the second light passing portion 41 of the light emitter 4 in an optical-axis direction 81. In FIG. 9B, the second light passing portion 41 of the light emitter 4 and the focus position Bw of the emission light Lo substantially match each other in the optical-axis direction 81. In FIG. 9C, the focus position Bw of the emission light Lo is located on the side opposite to the movable light reflector 3 with respect to the second light passing portion 41 of the light emitter 4 in the optical-axis direction 81. Changing the position of the concave diffraction grating 2 in the first tangential direction 82 can change the position of the focus position Bw in the optical-axis direction 81 as illustrated in FIG. 9A to FIG. 9C. Thus, adjustment can be performed to substantially align the second light passing portion 41 and the focus position Bw with each other.

The direction in which the position of the concave diffraction grating 2 is changed is the longitudinal direction of the concave diffraction grating 2. Thus, two reference points can be set at positions apart from each other at the positional change, and a deviation of the concave diffraction grating 2 in the rotation direction around the grating direction due to the positional change can be suppressed.

In the present embodiment, as illustrated in FIG. 7, the position of the light emitter 4 is changeable in the optical-axis direction 81 of the emission light Lo emitted from the light emitter 4. The optical-axis direction 81 of the emission light Lo corresponds to a direction along the center axis of the emission light Lo. Changing the position of the light emitter 4 can provide adjustment to substantially align the second light passing portion 41 and the focus position Bw with each other.

Scanning with the emission light Lo is provided by the movable light reflector 3 in the spectroscope 10 in a direction intersecting with the optical-axis direction 81. Thus, the positional deviation of the focus position Bw in the direction intersecting with the optical-axis direction 81 does not affect the light intensity, wavelength resolution, and so forth, of the emission light Lo unless the positional deviation extremely varies, and hence the position of the light emitter 4 may be changed at least in the optical-axis direction 81.

The positional change of the light emitter 4 has a less influence on the optical characteristics other than the change in focus position Bw in the optical-axis direction 81 as compared to the positional changes of the other components in the spectroscope 10, and hence the adjustment to substantially align the focus position Bw and the second light passing portion 41 with each other can be stably performed.

As described above, in the present embodiment, the positions of the components in the spectroscope 10 can be adjusted. In the present embodiment, the position of the concave diffraction grating 2 is changed in the first tangential direction 82 of the Rowland circle 7, or the position of the light emitter 4 is changed in the optical-axis direction 81, thereby substantially aligning the focus position Bw of the emission light Lo with the position of the second light passing portion 41. Since the focus position Bw of the emission light Lo is substantially aligned with the position of the second light passing portion 41, an individual difference in performance of each spectroscope 10 can be reduced.

For example, the position of the light emitter 4 can be changed so that the focus position Bw of the emission light Lo to be emitted from the light emitter 4 overlaps the position at which the emission light Lo to be emitted from the light emitter 4 passes through the light emitter 4. The position of each of the concave diffraction grating 2 and the light emitter 4 may be changeable so that the light intensity of the emission light Lo from the light emitter 4 is maximized. The position of each of the concave diffraction grating 2 and the light emitter 4 may be changeable so that the wavelength resolution of the emission light Lo from the light emitter 4 is maximized. The position of each of the concave diffraction grating 2 and the light emitter 4 may be changeable so that the wavelength shift of the emission light Lo from the light emitter 4 is minimized. Furthermore, two or more of the above-described positional changes may be combined as appropriate. With any of the positional changes, an advantageous effect of reducing the individual difference in performance of each spectroscope can be obtained.

### Example of Positional Change of Light Incidence Section 1

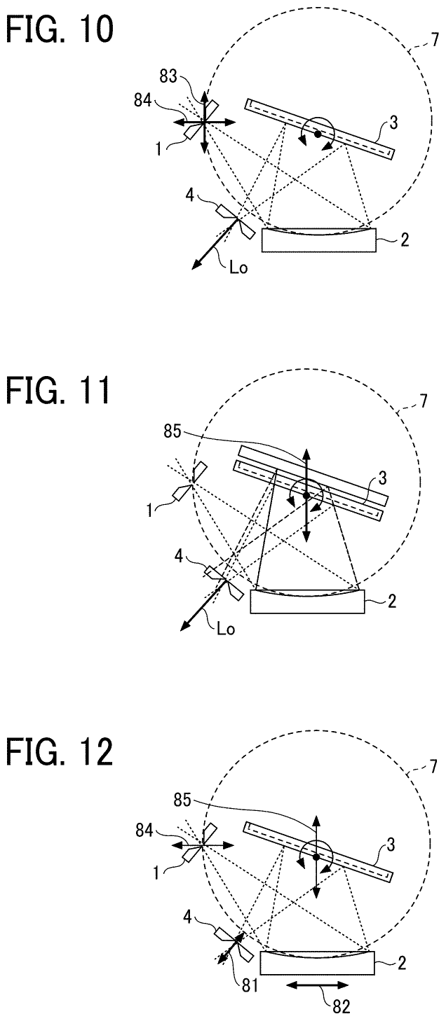

FIG. 10 is a diagram illustrating an example of a positional change of the light incidence section 1. When the position of the light incidence section 1 is changed in a second tangential direction 83 or a radial direction 84 of the Rowland circle 7 near the position at which the light incidence section 1 is disposed, the relative positions of the concave diffraction grating 2 and the light incidence section 1 are changed. Accordingly, an advantageous effect similar to that in the case where the position of the concave diffraction grating 2 is changed in the first tangential direction 82 can be obtained. Which one of the second tangential direction 83 and the radial direction 84 the position is changed along can be appropriately selected in accordance with the clearance with respect to another component, the space in which the position can be changed, and so forth.

### Example of Positional Change of Movable Light Reflector 3

FIG. 11 is a diagram illustrating an example of a positional change of the movable light reflector 3. As illustrated in FIG. 11, when the position of the movable light reflector 3 is changed in a direction away from the concave diffraction grating 2 in a movement direction 85, the focus position Bw of the emission light Lo changes to a position on the movable light reflector 3 side with respect to the light emitter 4. The movable light reflector 3 changes the position in the optical-axis direction of the light incident on the movable light reflector 3 to change the focus position Bw of the emission light Lo and to substantially align the focus position Bw with the position of the second light passing portion 41 of the light emitter 4.

### Example of Positional Changes of Light Incidence Section 1, Concave Diffraction Grating 2, Movable Light Reflector 3, and Light Emitter 4

FIG. 12 is a diagram illustrating an example in a state in which the position of each of the light incidence section 1, the concave diffraction grating 2, the movable light reflector 3, and the light emitter 4 is changeable. The positions of at least two of the light incidence section 1, the concave diffraction grating 2, the movable light reflector 3, and the light emitter 4 are changeable, and hence the focus position Bw can be substantially aligned with the position of the second light passing portion 41 of the light emitter 4 even when the dimensional tolerance, mounting tolerance, or assembly tolerance of each of the components is large. Accordingly, robustness with respect to a manufacturing error or the like of each component can be enhanced, performance of the spectroscope 10 can be highly ensured, and an individual difference of the spectroscope 10 can be reduced. In addition, the positions of the plurality of components can be changed, and hence the range of change in position per component can be decreased, thereby downsizing the spectroscope 10.

Each of the components in the spectroscope 10 including the light incidence section 1, the concave diffraction grating 2, the movable light reflector 3, and the light emitter 4 is secured in a housing or by a support so as to maintain the predetermined position and posture. Thus, the position of each of the components may be changed by changing the position of the support. There is no particular limitation on the system, shape, or the like, of the position change mechanism.

When the light detector 6 is installed near the light emitter 4, the position of the light emitter 4 can be changed simultaneously with the positional change of the light detector 6. By performing the positional changes simultaneously, a deviation in alignment between the light emitter 4 and the light detector 6 is not generated, and the optical characteristics of the spectroscope 10 can be stabilized.

### Example of Angle Adjustment Mechanism of Concave Diffraction Grating 2

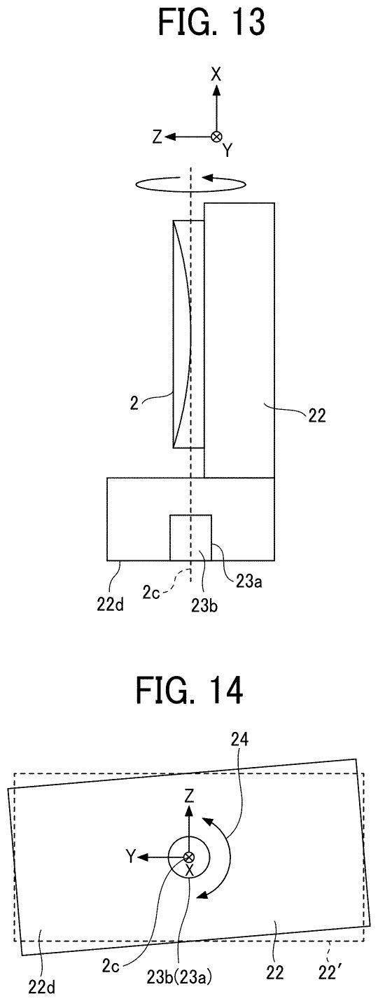

FIGS. 13 and 14 are views illustrating an example of an angle adjustment mechanism 22 of the concave diffraction grating 2. FIG. 13 is a cross-sectional view, and FIG. 14 is a bottom view. As illustrated in FIGS. 13 and 14, the angle adjustment mechanism 22 has a recessed portion 23a in a lower surface 22d. The recessed portion 23a is fitted to a positioning pin 23b having a columnar shape. The positioning pin 23b has a columnar shaft that is substantially parallel to the vertical direction, and substantially coincides with a rotation axis 2c of the angle adjustment mechanism 22.

The angle adjustment mechanism 22 swings around the rotation axis 2c (in a direction indicated by arrow 24) to swing the concave diffraction grating 2 held by the angle adjustment mechanism 22 around the rotation axis 2c. An angle adjustment mechanism 22′ in FIG. 14 represents an angle adjustment mechanism before the swing, and the angle adjustment mechanism 22 represents an angle adjustment mechanism after the swing by a predetermined rotation angle around the rotation axis 2c from the state of the angle adjustment mechanism 22′.

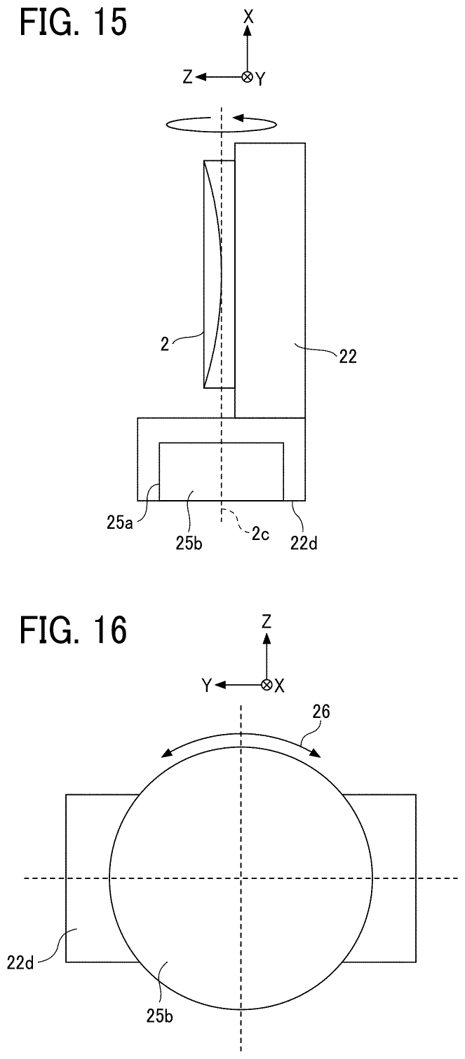

FIGS. 15 and 16 illustrate another example of the angle adjustment mechanism of the concave diffraction grating 2. FIG. 15 is a cross-sectional view, and FIG. 16 is a bottom view. As illustrated in FIGS. 15 and 16, the angle adjustment mechanism 22 has a recessed portion 25a in the lower surface 22d. The recessed portion 25a is fitted to a guide member 25b having a columnar shape. The guide member 25b has a columnar shaft that is substantially parallel to the vertical direction, and substantially coincides with the rotation axis 2c of the angle adjustment mechanism 22.

The angle adjustment mechanism 22 swings around the rotation axis 2c (in a direction indicated by arrow 26) to swing the concave diffraction grating 2 held by the angle adjustment mechanism 22 around the rotation axis 2c.

In the present embodiment, a spectroscope 10 includes a light incidence section 1 (light incidence means) that allows light Li from an outside to be incident; a concave diffraction grating 2 (diffraction grating) that disperses wavelengths of the light Li incident on the concave diffraction grating 2 by the light incidence section 1; a movable light reflector 3 (reflecting means) having a reflecting surface 32 having an inclination variable around a rotation axis of the reflecting surface 32; and a light emitter 4 (light emitting means) that emits the light reflected by the movable light reflector 3 to the outside. At least two of positions of the light incidence section 1, the concave diffraction grating 2, the movable light reflector 3, and the light emitter 4 are changeable in a direction orthogonal to the rotation axis of the reflecting surface 32. The position of the light emitter 4 is changeable in a direction along a center axis of the light emitted from the light emitter 4. With this configuration, the positions of components in the spectroscope can be adjusted.

In the present embodiment, at least one of the positions of the light incidence section 1, the concave diffraction grating 2, the movable light reflector 3, and the light emitter 4 is adjustable in a direction orthogonal to the rotation axis of the reflecting surface 32. With this configuration, regardless of the dimensional tolerance or assembly tolerance of a component, a decrease in light intensity of emission light, a deterioration in wavelength resolution, and a deterioration in wavelength precision can be suppressed, and an individual difference in spectral performance can be reduced.

In the present embodiment, the position of the concave diffraction grating 2 may be adjustable, and based on an assumption that a direction along the rotation axis of the movable light reflector 3 is an X-axis, a direction from a center of the concave diffraction grating 2 toward a center of curvature of the concave diffraction grating 2 is a Z-axis, and an axis orthogonal to each of the X-axis and the Z-axis is a Y-axis, the position of the concave diffraction grating 2 may be adjustable in a direction along the Y-axis. With this configuration, the positions of the concave diffraction grating 2 and the light emitter 4 are adjustable, and hence the spectral performance can be stably improved.

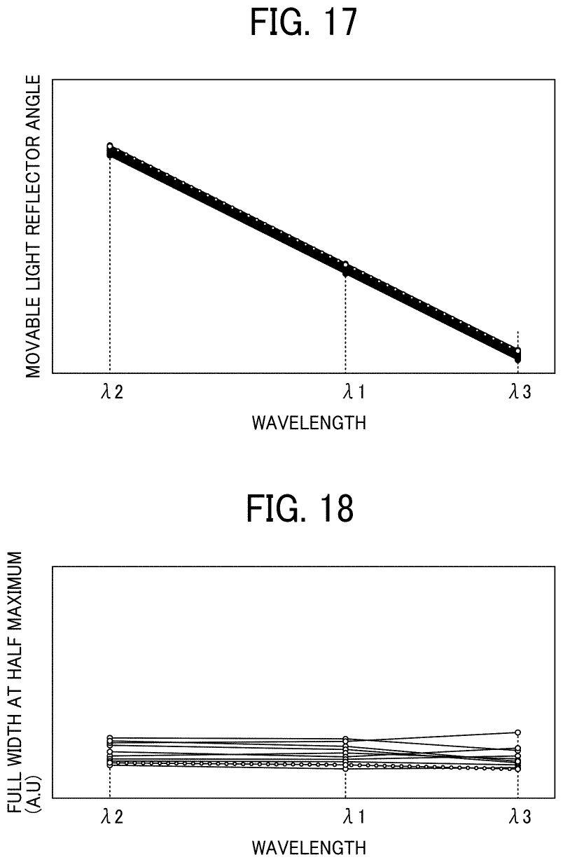

In the present embodiment, the position of the concave diffraction grating 2 may be adjusted so that the light incidence section 1 and the light emitter 4 are located on a Rowland circle formed by the concave diffraction grating 2. With this configuration, a Rowland arrangement can be provided, and the spectral performance can be increased. FIG. 17 is a graph presenting angles of the movable light reflector 3 in a case where predetermined tolerances are given to the position and posture of each of the concave diffraction grating 2, the movable light reflector 3, and the light emitter 4 and the position of the concave diffraction grating 2 is adjusted. As illustrated in FIG. 17, adjusting the position of the concave diffraction grating 2 can significantly reduce a variation in angle.

In the present embodiment, the position of the light emitter 4 may be adjustable, and based on an assumption that a direction along the rotation axis of the movable light reflector 3 is an X-axis, a direction normal to a surface of the light emitter 4 is a Z-axis, and an axis orthogonal to each of the X-axis and the Z-axis is a Y-axis, the position of the light emitter 4 may be adjustable in a direction along the Z-axis. With this configuration, the positions of the concave diffraction grating 2 and the light emitter 4 are adjustable, and hence the spectral performance can be stably improved. FIG. 18 is a graph presenting values of full width at half maximum of light illuminance when light having each of the wavelengths λ1, λ2, and λ3 passes through the second light passing portion 41 with the highest light intensity in a case where predetermined tolerances are given to the position and posture of each of the concave diffraction grating 2, the movable light reflector 3, and the light emitter 4 and the position of the light emitter 4 is adjusted. As illustrated in FIG. 18, adjusting the light emitter 4 can reduce an increase in full width at half maximum.

In the present embodiment, the position of the light emitter 4 may be adjusted so that the light incidence section 1 and the light emitter 4 have an optically conjugate relationship. With this configuration, the focus position can be aligned with the position of the second light passing portion 41, and the spectral performance can be increased.

In the present embodiment, each of the positions of the concave diffraction grating 2 and the light emitter 4 may be adjustable, and each of the concave diffraction grating 2 and the light emitter 4 may be disposed at a position at which a wavelength shift is minimized. With this configuration, it is possible to reduce the wavelength shift that is wavelength-dependent, thereby increasing the wavelength precision and increasing the spectral performance.

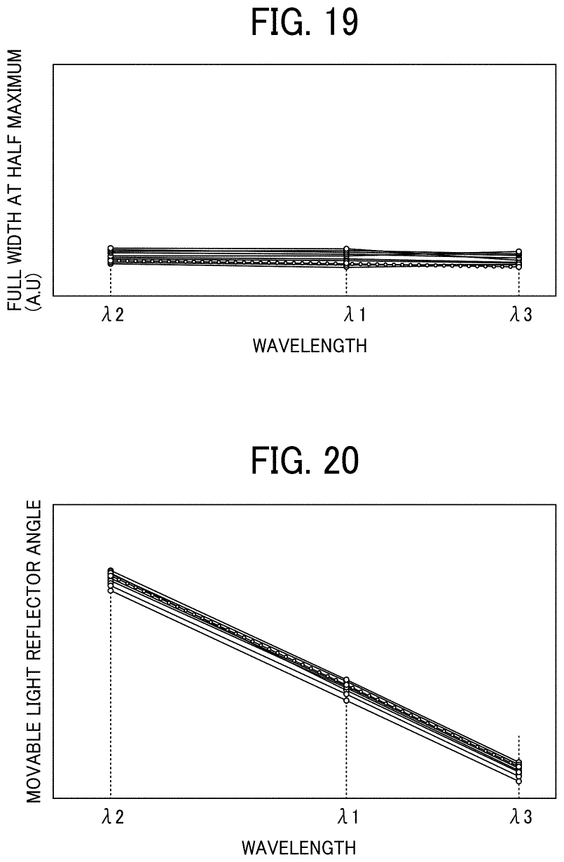

In the present embodiment, each of the positions of the concave diffraction grating 2 and the light emitter 4 may be adjustable, and each of the concave diffraction grating 2 and the light emitter 4 may be disposed at a position at which a wavelength resolution is maximized. With this configuration, the wavelength resolution is increased, and hence the spectral performance can be increased. FIG. 19 is a graph presenting values of full width at half maximum of light illuminance when light having each of the wavelengths λ1, λ2, and λ3 passes through the second light passing portion 41 with the highest light intensity in a case where predetermined tolerances are given to the position and posture of each of the concave diffraction grating 2, the movable light reflector 3, and the light emitter 4 and the positions of the concave diffraction grating 2 and the light emitter 4 are adjusted simultaneously. As illustrated in FIG. 19, adjusting the positions of the concave diffraction grating 2 and the light emitter 4 simultaneously can reduce an increase in full width at half maximum as compared to the case where the position of the light emitter 4 is adjusted.

In the present embodiment, each of the positions of the concave diffraction grating 2 and the light emitter 4 may be adjustable, and each of the concave diffraction grating 2 and the light emitter 4 may be disposed at a position at which a light intensity of light passing through the light emitter 4 is maximized. Maximizing the light intensity of light passing through the light emitter 4 can increase the SN ratio and increase the spectral performance.

In the present embodiment, at least one of postures of the light incidence section 1, the concave diffraction grating 2, and the light emitter 4 may be rotated around an axis parallel to the rotation axis of the movable light reflector 3 to adjust the at least one of the postures of the light incidence section 1, the concave diffraction grating 2, and the light emitter 4. With this configuration, regardless of the dimensional tolerance or assembly tolerance of a component, a decrease in light intensity of emission light, a deterioration in wavelength resolution, and a deterioration in wavelength precision can be suppressed, and an individual difference in spectral performance can be reduced.

In the present embodiment, the posture of the concave diffraction grating 2 may be adjustable, and the axis parallel to the rotation axis of the movable light reflector 3 may pass through a center of the concave diffraction grating 2. FIG. 20 is a graph presenting angles of the movable light reflector 3 in a case where predetermined tolerances are given to the position and posture of each of the concave diffraction grating 2, the movable light reflector 3, and the light emitter 4 and the posture of the concave diffraction grating 2 is adjusted. As illustrated in FIG. 20, adjusting the posture of the concave diffraction grating 2 can significantly reduce a variation in angle.

### Second Embodiment

An analysis system 300 including the spectroscope 10 according to the first embodiment is described next as a second embodiment. The same name and reference sign of the above-described embodiment denote members or components identical or equivalent to those of the above-described embodiment, and the detailed description thereof is appropriately omitted.

### Example of Configuration of Analysis System 300

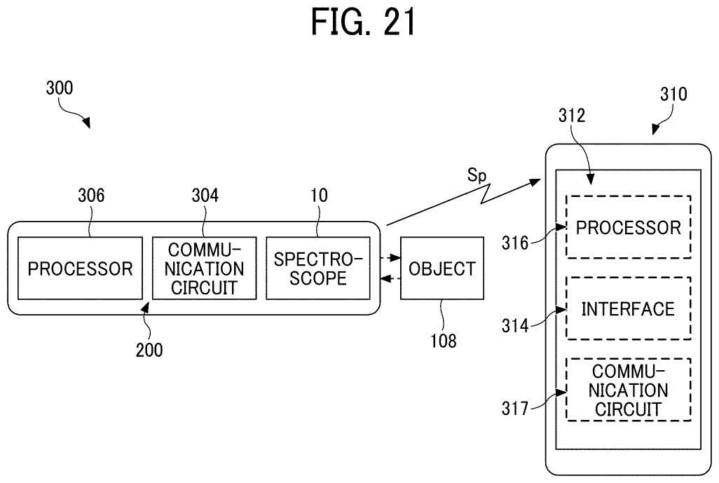

FIG. 21 illustrates an example of a general arrangement of the analysis system 300. As illustrated in FIG. 21, the analysis system 300 includes a portable apparatus 200 and a portable terminal 310. The portable apparatus 200 includes the spectroscope 10, a processor 306, and a communication circuit 304.

The analysis system 300 may have a configuration in which one spectroscope 10 is provided for one portable terminal 310, or a configuration in which a plurality of spectroscopes 10 are provided for one portable terminal 310.

The processor 306 receives an input of an electric signal that is output from the spectroscope 10, and acquires information in which a time of an optical spectrum is associated with an output including a light intensity by computation. The communication circuit 304 outputs the result obtained by the processor 306 to the portable terminal 310.

The portable terminal 310 includes an interface 314, a processor 316, and a communication circuit 317. The portable terminal 310 is, for example, a portable device such as a smartphone or a tablet terminal. The portable terminal 310 may have a camera function.

The processor 316 receives information Sp associated with the output including the time of the optical spectrum and the light intensity output from the communication circuit 304 of the portable apparatus 200 using the communication circuit 317. The processor 316 converts the time into a wavelength of light based on the received information Sp and a rotation frequency, a rotation angle amplitude, or the like, of the movable light reflector 3 included in the spectroscope 10 to obtain optical spectrum information Sq defined in relation to a light intensity on a wavelength of light basis. The processor 316 also acquires an analysis result such as a composition determination result of an object 108 by computation using the obtained optical spectrum information Sq.

The processor 316 can display the analysis result on a display 312 via the interface 314.

In the analysis system 300, the portable apparatus 200 transmits data to the portable terminal 310 via the communication circuit 304 using, for example, wireless serial communication such as Bluetooth. The portable terminal 310 receives data from the portable apparatus 200 and processes and analyzes the data using the processor 316. The analysis system 300 causes the display 312 to display, for example, the optical spectrum information Sq and the composition determination result, which are the analysis result.

### Example of Operation of Analysis System 300

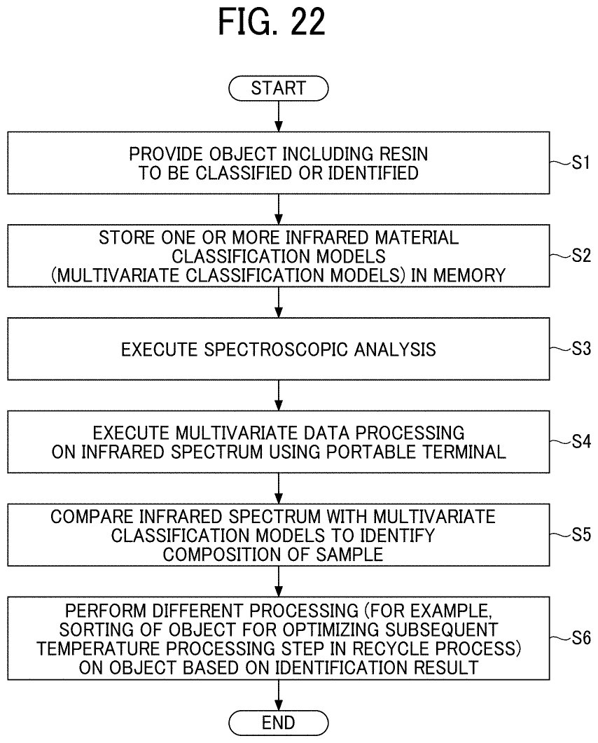

FIG. 22 is a flowchart presenting an example of a resin determination operation when the analysis system 300 is applied to a resin determination apparatus.

In step S1, the analysis system 300 provides an object including a resin to be classified or identified.

In step S2, the analysis system 300 stores one or more infrared material classification models (multivariate classification models) in a memory.

In step S3, the analysis system 300 executes spectroscopic analysis on the object 108 to collect raw infrared spectrum data.

In step S4, the analysis system 300 executes multivariate processing on the raw infrared spectrum data using the processor 316 of the portable terminal 310.

In step S5, the analysis system 300 uses the processor 316 of the portable terminal 310 to identify the composition of a sample as a resin-based composite material of a specific type (corresponding to the material model).

In step S6, the analysis system 300 further processes the object 108 (for example, stores the object 108 in a proper location for a further recycle step). The analysis system 300 can repeat each processing from step S1 to step S6 for an object 108 including another resin in step S3.

For example, the analysis system 300 uses a classification model to identify the composition of the object 108 including a resin, and determines a resin that a sample including a specific resin may include. For example, determining a resin using the analysis system 300 can optimize processing conditions of a process such as optimizing processing conditions of a furnace to be used for material processing in the recycle of the object 108 including the resin.

Moreover, processing of registering known material data before execution of the spectroscopic analysis in the operation in FIG. 22 can be added. With this processing, the precision of the analysis result of the object 108 can be increased. As described above, the analysis system 300 can determine a resin with high reliability.

Although the preferred embodiments of the present disclosure are described above in detail, the present disclosure is not limited to such specific embodiments, and the embodiments may be modified and changed in various ways without departing from the spirit and scope of the present disclosure as set forth in the appended claims.

For example, the spectroscope 10 according to the embodiment may be used for an analysis apparatus. For example, such an analysis apparatus is used to identify the type of resin or the like of an object by spectroscopic analysis on the spectrum obtained by the spectroscope 10, and to sort and recover the object for each type of resin as a recycled material. Since the analysis apparatus includes the spectroscope 10, highly precise analysis in which the influence of stray light is reduced can be performed, and the analysis apparatus can be downsized.

Aspects of the present disclosure are, for example, as follows.

According to a first aspect, a spectroscope includes light incidence means that allows light from an outside to be incident; a diffraction grating that disperses wavelengths of the light incident on the diffraction grating by the light incidence means; reflecting means having a reflecting surface having an inclination variable around a rotation axis of the reflecting surface; and light emitting means that emits the light reflected by the reflecting means to the outside. At least two of positions of the light incidence means, the diffraction grating, the reflecting means, and the light emitting means are changeable in a direction orthogonal to the rotation axis. The position of the light emitting means is changeable in a direction along a center axis of the light emitted from the light emitting means.

According to a second aspect, in the spectroscope of the first aspect, the diffraction grating includes a plurality of gratings arranged in a predetermined direction. The position of the diffraction grating is changeable in the predetermined direction.

According to a third aspect, in the spectroscope of the first aspect or the second aspect, the diffraction grating is a concave diffraction grating. Each of the light incidence means and the concave diffraction grating is arranged on a Rowland circle. The position of the concave diffraction grating is changeable in a tangential direction of the Rowland circle at the position at which the concave diffraction grating is disposed.

According to a fourth aspect, in the spectroscope of any one of the first aspect to the third aspect, the position of the light emitting means is changeable so that a focus position of the light to be emitted from the light emitting means overlaps a position at which the light to be emitted from the light emitting means passes through the light emitting means.

According to a fifth aspect, in the spectroscope of any one of the first aspect to the fourth aspect, each of the positions of the diffraction grating and the light emitting means is changeable so that a light intensity of the light emitted from the light emitting means is maximized.

According to a sixth aspect, in the spectroscope of any one of the first aspect to the fifth aspect, each of the positions of the diffraction grating and the light emitting means is changeable so that a wavelength resolution of the light emitted from the light emitting means is maximized.

According to a seventh aspect, in the spectroscope of any one of the first aspect to the sixth aspect, each of the positions of the diffraction grating and the light emitting means is changeable so that a wavelength shift of the light emitted from the light emitting means is minimized.

According to an eighth aspect, a spectroscope includes light incidence means that allows light from an outside to be incident; a concave diffraction grating that disperses wavelengths of the light incident on the concave diffraction grating by the light incidence means; reflecting means having a reflecting surface swingable around a predetermined rotation axis, and light emitting means that emits the light reflected by the reflecting means to the outside. At least one of positions of the light incidence means, the concave diffraction grating, the reflecting means, and the light emitting means is adjustable in a direction orthogonal to the rotation axis.

According to a ninth aspect, in the spectroscope of the eighth aspect, the position of the concave diffraction grating is adjustable, and based on an assumption that a direction along the rotation axis of the reflecting means is an X-axis, a direction from a center of the concave diffraction grating toward a center of curvature of the concave diffraction grating is a Z-axis, and an axis orthogonal to each of the X-axis and the Z-axis is a Y-axis, the position of the concave diffraction grating is adjustable in a direction along the Y-axis.

According to a tenth aspect, in the spectroscope of the eighth aspect or the ninth aspect, the position at which the concave diffraction grating is disposed is adjusted so that the light incidence means and the light emitting means are located on a Rowland circle formed by the concave diffraction grating.

According to an eleventh aspect, in the spectroscope of any one of the eighth aspect to the tenth aspect, the position of the light emitting means is adjustable, and based on an assumption that a direction along the rotation axis of the reflecting means is an X-axis, a direction normal to a surface of the light emitting means is a Z-axis, and an axis orthogonal to each of the X-axis and the Z-axis is a Y-axis, the position of the light emitting means is adjustable in a direction along the Z-axis.

According to a twelfth aspect, in the spectroscope of any one of the eighth aspect to the eleventh aspect, the position of the light emitting means is adjusted so that the light incidence means and the light emitting means have an optically conjugate relationship.

According to a thirteenth aspect, in the spectroscope of any one of the eighth aspect to the twelfth aspect, each of the positions of the concave diffraction grating and the light emitting means is adjustable, and each of the concave diffraction grating and the light emitting means is disposed at a position at which a wavelength shift is minimized.

According to a fourteenth aspect, in the spectroscope of any one of the eighth aspect to the thirteenth aspect, each of the positions of the concave diffraction grating and the light emitting means is adjustable, and each of the concave diffraction grating and the light emitting means is disposed at a position at which a wavelength resolution is maximized.

According to a fifteenth aspect, in the spectroscope of any one of the eighth aspect to the fourteenth aspect, each of the positions of the concave diffraction grating and the light emitting means is adjustable, and each of the concave diffraction grating and the light emitting means is disposed at a position at which a light intensity of the light passing through the light emitting means is maximized.

According to a sixteenth aspect, a spectroscope includes light incidence means that allows light from an outside to be incident; a concave diffraction grating that disperses wavelengths of the light incident on the concave diffraction grating by the light incidence means; reflecting means having a reflecting surface swingable around a predetermined rotation axis; and light emitting means that emits the light reflected by the reflecting means to the outside. At least one of postures the light incidence means, the concave diffraction grating, and the light emitting means is rotated around an axis parallel to the rotation axis to adjust the at least one of the postures of the light incidence means, the concave diffraction grating, and the light emitting means.

According to a seventeenth aspect, in the spectroscope of the sixteenth aspect, the posture of the concave diffraction grating is adjustable, and the axis parallel to the rotation axis passes through a center of the concave diffraction grating.

According to an eighteenth aspect, an analysis system includes the spectroscope of any one of the first aspect to the seventeenth aspect.

Any one of the above-described operations may be performed in various other ways, for example, in an order different from the one described above.

The functionality of the elements disclosed herein may be implemented using circuitry or processing circuitry which includes general purpose processors, special purpose processors, integrated circuits, application specific integrated circuits (ASICs), digital signal processors (DSPs), field programmable gate arrays (FPGAs), conventional circuitry and/or combinations thereof which are configured or programmed to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein or otherwise known which is programmed or configured to carry out the recited functionality. When the hardware is a processor which may be considered a type of circuitry, the circuitry, means, or units are a combination of hardware and software, the software being used to configure the hardware and/or processor.

1. A spectroscope comprising:
a light incidence section configured to allow light from an outside to be incident;
a diffraction grating configured to disperse wavelengths of the light incident on the diffraction grating by the light incidence section;
a light reflector having a reflecting surface having an inclination variable around a rotation axis of the reflecting surface; and
a light emitter configured to emit the light reflected by the light reflector to the outside,
wherein at least one of the light incidence section, the diffraction grating, and the light reflector, and the light emitter are changeable in a direction orthogonal to the rotation axis, and
wherein the position of the light emitter is changeable in a direction along a center axis of the light emitted from the light emitter.

2. The spectroscope according to claim 1,
wherein the diffraction grating includes a plurality of gratings arranged in a predetermined direction, and
wherein, in a case that the diffraction grating is the one that is changeable, the position of the diffraction grating is changeable in the predetermined direction.

3. The spectroscope according to claim 1,
wherein the diffraction grating is a concave diffraction grating,
wherein each of the light incidence section and the concave diffraction grating is arranged on a Rowland circle, and
wherein, in a case that the concave diffraction grating is the one that is changeable, the position of the concave diffraction grating is changeable in a tangential direction of the Rowland circle at the position at which the concave diffraction grating is disposed.

4. The spectroscope according to claim 1, wherein, in a case that the light emitter is the one that is changeable, the position of the light emitter is changeable so that a focus position of the light to be emitted from the light emitter overlaps a position at which the light to be emitted from the light emitter passes through the light emitter.

5. The spectroscope according to claim 1, wherein, in a case that each of the diffraction grating and the light emitter is the one that is changeable, a light intensity of the light emitted from the light emitter is maximized.

6. The spectroscope according to claim 1, wherein, in a case that each of the positions of the diffraction grating and the light emitter is changed, a wavelength resolution of the light emitted from the light emitter is maximized.

7. The spectroscope according to claim 1, wherein, in a case that each of the positions of the diffraction grating and the light emitter is changed, a wavelength shift of the light emitted from the light emitter is minimized.

8. A spectroscope comprising:
a light incidence section configured to allow light from an outside to be incident;
a concave diffraction grating configured to disperse wavelengths of the light incident on the concave diffraction grating by the light incidence section;
a light reflector having a reflecting surface swingable around a predetermined rotation axis; and
a light emitter configured to emit the light reflected by the light reflector to the outside,
wherein at least one of positions of the light incidence section, the concave diffraction grating, the light reflector, and the light emitter is adjustable in a direction orthogonal to the rotation axis.

9. The spectroscope according to claim 8, wherein, in a case that the position of the concave diffraction grating is adjustable, based on an assumption that a direction along the rotation axis of the light reflector is an X-axis, a direction from a center of the concave diffraction grating toward a center of curvature of the concave diffraction grating is a Z-axis, and an axis orthogonal to each of the X-axis and the Z-axis is a Y-axis, the position of the concave diffraction grating is adjustable in a direction along the Y-axis.

10. The spectroscope according to claim 8, wherein the position at which the concave diffraction grating is disposed is adjusted so that the light incidence section and the light emitter are located on a Rowland circle formed by the concave diffraction grating.

11. The spectroscope according to claim 8, wherein, in a case that the position of the light emitter is adjustable, based on an assumption that a direction along the rotation axis of the light reflector is an X-axis, a direction normal to a surface of the light emitter is a Z-axis, and an axis orthogonal to each of the X-axis and the Z-axis is a Y-axis, the position of the light emitter is adjustable in a direction along the Z-axis.

12. The spectroscope according to claim 8, wherein the position of the light emitter is adjusted so that the light incidence section and the light emitter have an optically conjugate relationship.

13. The spectroscope according to claim 8, wherein each of the positions of the concave diffraction grating and the light emitter is adjustable, and each of the positions is a position at which a wavelength shift is minimized.

14. The spectroscope according to claim 8, wherein each of the positions of the concave diffraction grating and the light emitter is adjustable, and each of the positions is a position at which a wavelength resolution is maximized.

15. The spectroscope according to claim 8, wherein each of the positions of the concave diffraction grating and the light emitter is adjustable, and each of the positions is a position at which a light intensity of the light passing through the light emitter is maximized.

16. A spectroscope comprising:
a light incidence section configured to allow light from an outside to be incident;
a concave diffraction grating configured to disperse wavelengths of the light incident on the concave diffraction grating by the light incidence section;
a light reflector having a reflecting surface swingable around a predetermined rotation axis; and
a light emitter configured to emit the light reflected by the light reflector to the outside,
wherein at least one of postures of the light incidence section, the concave diffraction grating, and the light emitter is rotated around an axis parallel to the rotation axis to adjust the at least one of the postures of the light incidence section, the concave diffraction grating, and the light emitter.

17. The spectroscope according to claim 16, wherein, in a case that the posture of the concave diffraction grating is adjustable, the axis parallel to the rotation axis passes through a center of the concave diffraction grating.

18. An analysis system comprising:
the spectroscope according to claim 1; and
circuitry configured to analyze a spectrum obtained by the spectroscope.

19. An analysis system comprising:
the spectroscope according to claim 8; and
circuitry configured to analyze a spectrum obtained by the spectroscope.

20. An analysis system comprising:
the spectroscope according to claim 16; and
circuitry configured to analyze a spectrum obtained by the spectroscope.
